(19) United States
(12) Patent Application Publication
(10) Pub. No.: US 2017/0243146 A1
(43) Pub. Date: Aug. 24, 2017

(54) ENTERPRISE SERVICE BLUEPRINT GENERATOR

(71) Applicant: HEWLETT PACKARD ENTERPRISE DEVELOPMENT LP, Houston, TX (US)

(72) Inventors: Reinier J. AERDTS, Plano, TX (US); Parag M. DOSHI, Marietta, GA (US); Chandra H. KAMALAKANTHA, Plano, TX (US)

(73) Assignee: HEWLETT PACKARD ENTERPRISE DEVELOPMENT LP, Houston, TX (US)

(21) Appl. No.: 15/500,047

(22) PCT Filed: Sep. 5, 2014
(86) PCT No.: PCT/US2014/054428

§ 371 Date: Jan. 28, 2017

(51) Int. Cl. G06Q 10/06

(52) U.S. Cl. CPC G06Q 10/06313; G06Q 10/067

(57) ABSTRACT

A method and apparatus receive an input indicating system service requirements. A repository is searched based upon the system service requirements to identify a solution model, the solution model comprising a framework of functional elements for the system service requirements. Criteria regarding the identified functional elements are received, and archetype and archetype products are identified based on the functional elements and the criteria. A system blueprint is generated comprising the archetype. products. The primary system blueprint comprises an application model and an infrastructure model, wherein the application model comprises a listing of archetype products and configuration settings for each archetype product and wherein the infrastructure model comprises specifications for an infrastructure connecting the archetype products.

### BACKGROUND

Enterprise services assist in the creation of information technology systems that facilitate data center management, information technology security, cloud computing, workplace technology, networks, unified communications and enterprise service management. Existing enterprise services rely upon individual craftsmanship and expertise of individual enterprise architects to transition from generic business objectives or goals to a specific enterprise service system blueprint that is sufficiently specific to allow a technician to build and deploy the enterprise service system. This process for generating and deploying enterprise service systems may be expensive while yielding inconsistent and less than optimal results that do not adequately align with the business objectives.

### BRIEF DESCRIPTION OF THE DRAWINGS

FIG. 1 is a schematic diagram of an example enterprise service system blueprint generator.

FIG. 2 is a diagram of an example solution model of the system of FIG. 1.

FIG. 3 is a diagram of an example archetypes of the system of FIG. 1.

FIG. 4 is a flow diagram of an example method for generating an enterprise service system blueprint.

FIG. 5 is a schematic diagram of another example enterprise service system blueprint generator.

FIG. 6 is a flow diagram of another example method for generating and enterprise service system blueprint.

FIG. 7 is a diagram of an example production deployment blueprint component.

FIG. 8 is a diagram of an example sequence blueprint component.

FIG. 9 is a block diagram of another example enterprise service system blueprint generator.

### DETAILED DESCRIPTION OF EXAMPLES

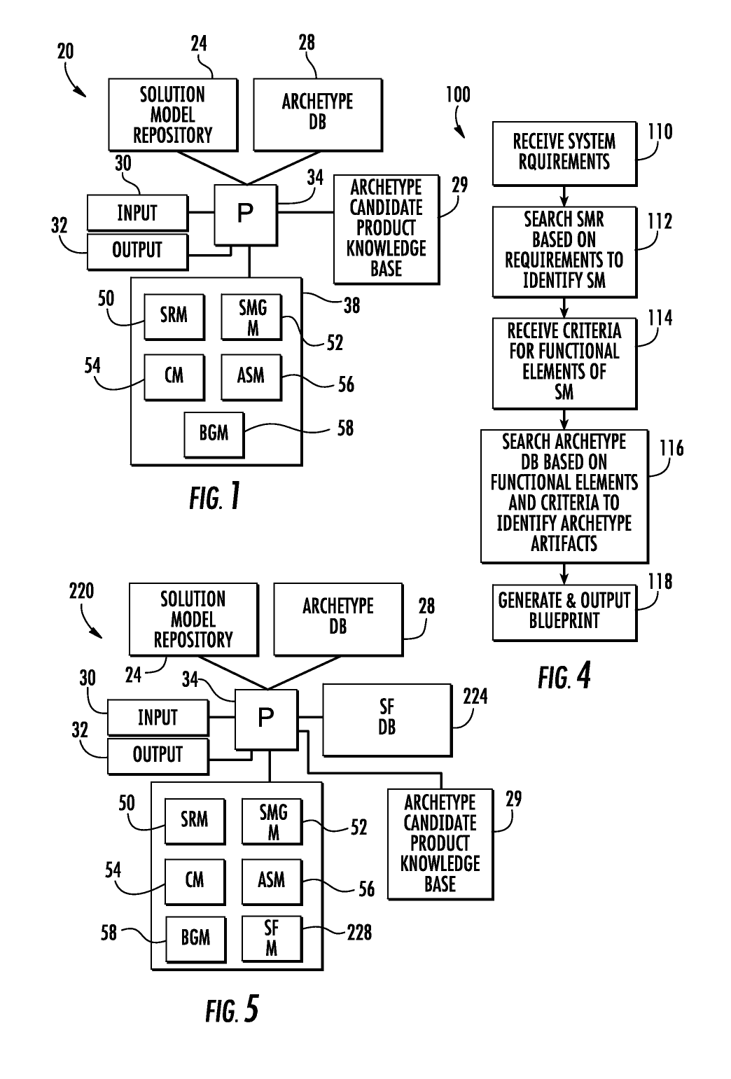

FIG. 1 schematically illustrates an example enterprise service blueprint generator 20. As will be described hereafter, enterprise service blueprint generator 20 comprises a computer implemented device that heuristically generates enterprise service blueprint having sufficient detail and specifications to facilitate assembly and deployment by a technician. As compared to prior manually created enterprise service blueprints which almost entirely rely upon the craftsmanship of individual enterprise architects, the heuristically generated enterprise service blueprints may offer greater consistency and better alignment with business objectives at a lower cost.

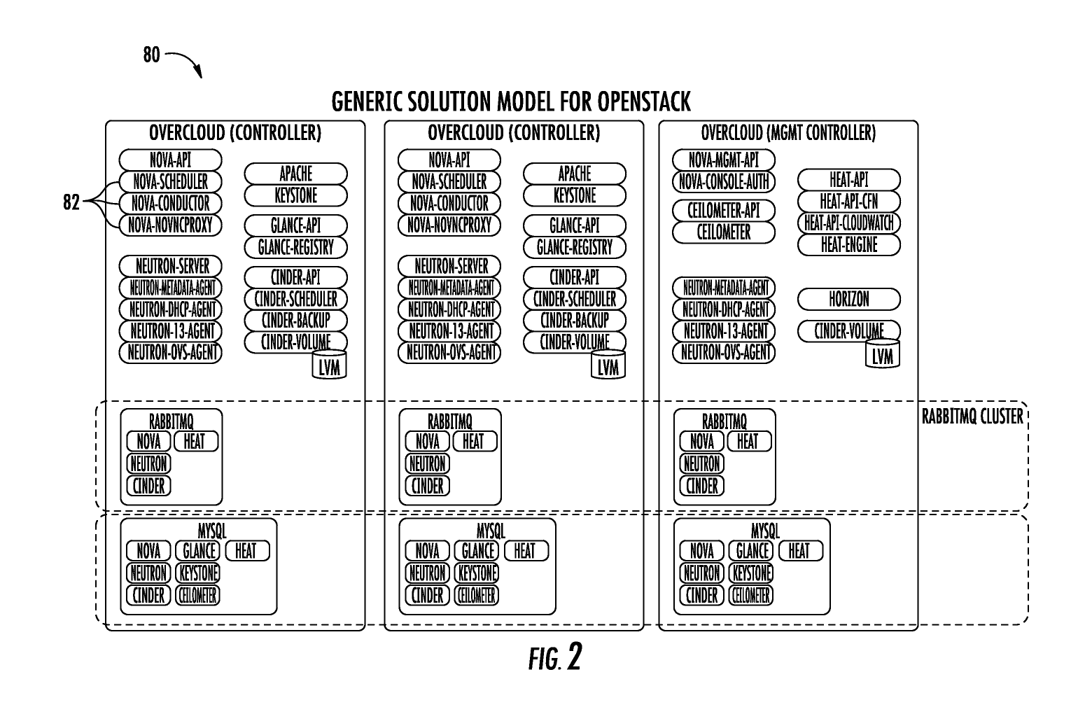

As shown by FIG. 1, enterprise service blueprint generator 20 comprises solution model repository 24, archetype database 28, archetype candidate product database 29, input 30, processor 34 and memory 38. Solution model repository 24 comprises a persistent memory storage device or server accessible database of various solution models such as business patterns, implementation patterns and computation models. Such solution models comprise a framework of functional elements and steps for achieving an end result. Such solution models do not have sufficient specificity for implementation and deployment of a service system, but comprise functional elements or steps that serve as a basic framework or outline for the subsequent generated blueprint, bridging between high level business and technical requirements for a system and the detailed product configurations and specifications of the blueprint. FIG. 2 illustrates one example of a solution model 80 for an open stack.

Archetype database 28 comprises a persistent memory storage device are server accessible database of archetypes artifacts. An archetype is a formal reusable pattern of the classes of components that may serve as the functional elements found in a solution model. FIG. 5 illustrates and example archetype or pattern 86 for an integrated enterprise Web application. As shown by FIG. 5, many of the components of the archetype are classes of hardware, software and the like rather than specific products or specific hardware, software and the like. In one implementation, archetype database 28 comprises metadata for each stored pattern or archetype, allowing each archetype to be searched based upon one or more characteristics such as based upon system requirements and/or based on whether a pattern includes the functional elements outlined a solution model.

Archetype candidate product knowledge base 29 comprises a database or knowledge base of various candidate products for the archetypes of database 28. In one implementation, such candidate products comprise actual specific commercially available products or not generally available product solutions that fall under the various product classes set forth in the archetypes stored in database 28. Knowledge-based 29 comprises metadata for each of the specific products, wherein such metadata comprises detailed information for each product such as product specifications, port and connector identifications, performance evaluations or metrics, compatibility specifications, survey results regarding performance or customer satisfaction, availability, CPU usage, data transfer rates, modularity, and cost, standard compliance and the like. Input 30 comprises a device by which system service requirements and more detailed criteria are input to generator 20. In one implementation input 30 comprises a keyboard, touchscreen, touchpad, microphone with associated speech recognition software or other input devices. In one implementation, input 30 additionally or alternatively comprises imager data capturing devices by which documents or memory storage devices containing business requirements and technical requirements are read.

Output 32 comprises a device upon which he generated blueprint resides for use. In one implementation, output 32 comprises a display screen, allowing the generated blueprint to be presented for viewing and modification by a user or enterprise service architect. In one implementation to output 32 comprises a touch screen, wherein both input 30 and output 32 are served by the touchscreen. In one implementation come up with 32 edition comprises a persistent memory or data storage device in which the blueprint is recorded for later retrieval and use.

Processor 34 comprises a processing unit that carries out instructions contained in memory 38 so as to generate an enterprise service system blueprint. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Unless otherwise specifically noted, processor 34 is not limited to any specific combination of hardware circuitry and software, nor to any particular source for the instructions executed by the processing unit.

Memory 38 comprises a non-transitory computer-readable medium containing software, code, instructions or other program logic for instructing or directing processor 34 to carry out various search operations with respect to repository 24 and database 28 based upon input received through input 30 so as to heuristically generate an enterprise service blueprint having sufficient detail and specifications to facilitate implementation and deployment by technician or having sufficient detail and specifications to allow an enterprise service architect to complete preparation of such a blueprint with reduced effort. In the example illustrated, memory 38 comprises service requirement module 50, solution model generation module 52, criteria module 54, archetype search module 56 and blueprint generation module 58. Service requirement module 50, solution model generation module 52, criteria module 54, archetype search module 56 and blueprint generation module 58 direct processor 34 to carry out the example method 100 outlined in the flow diagram of FIG. 2.

Service requirement module 50 comprises programmed logic that directs processor 34 to receive input, through input 30, indicating service or system requirements as indicated by block 110 in FIG. 2. Such system requirements may be in the form of technical requirements, driven by information technology requirements pertain to security, implementation, standard compliance and compatibility with existing components or protocols. Such system requirements may additionally or alternatively be in the form of business or industry requirements. Business or industry requirements may be functional business requirements, nonfunctional business requirements and technical requirements which are may be maintained in unstructured documents. Some example of technical requirements may be that the solution or parts of the solution are to solely utilize open-source technologies. Such requirements serve as constraints upon the ultimate enterprise service system to be built, but lacks sufficient specificity, in and of themselves, to facilitate building of the enterprise service system.

In one implementation, system requirements module 50 further directs process 34 to prompt a request the user or service architect to input a value, ranking or prioritization for each of the input system requirements. In such an implementation, solution model generation module 52 selects or builds the general solution model from repository 24 additionally based upon the value, ranking or prioritization for the criteria, such as where two different system requirements may not be completely satisfied by a single solution model. When such a conflict occurs, the prioritization values may serve as a tiebreaker.

In one implementation, system requirements module 52 prompts a user or enterprise services architect to provide information regarding the domain, such as a business or industry, in which the service system is to be employed. In such an implementation, the domain information is used by solution module generation module 52 and archetype search module 56 to filter out candidate solution models and candidate archetypes and archetype artifacts that are not relevant to the particular domain.

Solution model generation module 52 comprises programmed logic that directs processor 34 to search the solution model repository based upon requirements received in block 110, as indicated by block 112 in FIG. 2. In the example illustrated, solution model generation module 52 direct processor 34 to carry out keyword searches in the data of solution model repository 24. The results of the search comprise a solution model which comprises a framework of functional elements and steps for achieving an end result. Such solution models do not have sufficient specificity for implementation and deployment of a service system, but comprise functional elements or steps that serve as a basic framework or outline for the subsequent generated blueprint, bridging between high level business and technical requirements for a system and the detailed product configurations and specifications of the blueprint. The received a retrieve solution model serves as a source for identifying further input or criteria to be entered by an architect or other user.

Criteria module 54 comprises programmed logic that directs processor 34 to prompt the user or enterprise services architect for further input regarding criteria for functional elements of the solution model identified in block 112. In one implementation, such input is provided as part of an on-screen scripted criteria questionnaire or selectable graphical user interfaces. In one implementation, the questions are part of a multi-branched or tree-like scripted questionnaire, wherein the particular response to one question may lead to multiple follow-up questions depending upon the input. In one implementation, each solution model contained in repository 24 is associated with a listing of questions or input items for various variables associated with the solution model. In another implementation, criteria module 54 analyzes the identified solution model and further identifies variables for the identified solution model.

In one implementation, criteria model 54 direct processor 34 to automatically filter out or not present all of the questions or input items based upon the system requirements received in block 110. As a result, the criteria questionnaire is cropped, reducing or eliminating irrelevant or unnecessary questions based upon the received system requirements to reduce the amount of time consumed by the user architect responding to such prompts or answering such questions. As indicated by block 114 in FIG. 2, processor 34 receives the inputs or criteria for the various functional elements of the solution model identified in block 112.

The criteria input requested by criteria module 54 provides system 20 with additional specific constraints regarding the particular functional elements or components of the solution model identified in block 112. The criteria input identifies the specific nature and characteristics of the solution model to facilitate building of the final blueprint. Examples of criteria for which material module 54 directs processor to request and receive include such items as security specifications, availability specifications, supportability specifications and domain-industry-specific specifications. For example, the solution model for OpenStack attached calls out a highly-available RabbitMQ cluster typically used for guaranteed, reliable messaging based on open-source technologies.

Security specifications identify the levels of security for the functional elements or to what extent firewall other protections are in place in the solution model to eliminate or reduce a likelihood of breaches by hackers and the like. Availability specifications refers to the availability of the enterprise service. For example, what hours of the day, days of the week or days of a year that a website supported by the service should be up and running. Such specification indicate to what extent redundant or backup functional elements or components should be in place to allow modifications or upgrade without taking the website off-line or to account for other operational downages.

Supportability specifications refer to the extent or level of technical support for the functional elements of the solution model. Domain or industry-specific specifications refers to specifications that are germane to a particular domain or industry which the service system is operating. Such domain or industry-specific specifications may be driven by domain or industry standards.

In one implementation, criteria module 54 further directs process 34 to prompt a request the user or service architect to input a value, ranking or prioritization for each of the criteria or criteria areas. In such an implementation, archetype search module 56 selects the archetypes from database 28 additionally based upon the value, ranking or prioritization for the criteria, such as where two different criteria may not be completely satisfied by a single archetypes artifact or a group of archetypes artifacts. When such a conflict occurs, the prioritization values may serve as tiebreakers.

Archetype search module 56 comprises programmed logic that directs processor 34 to search archetype database 28 based upon the functional elements of the solution model identified in block 112 and the criteria received in block 114 to us to identify archetype artifacts as indicated by block 116 in FIG. 2. In the example illustrated, arc type search module 56 direct processor 34 to carry out keyword searches in the data of archetype database 28. The results of the search comprise an archetype or pattern of one or more classes of actual products that include the functional elements of the solution model in one implementation, the results of the search may identify multiple archetypes that are combinable with one another or which may be used in place of one another. archetype search module 56 directs processor 34 to conduct searches in summaries, abstracts, indexes or other metadata describing characteristics of each archetype stored in database 28, allowing each archetype to be searched to find the archetype or combination of archetypes that satisfy the functional elements outlined in the particular solution model thus to satisfy.

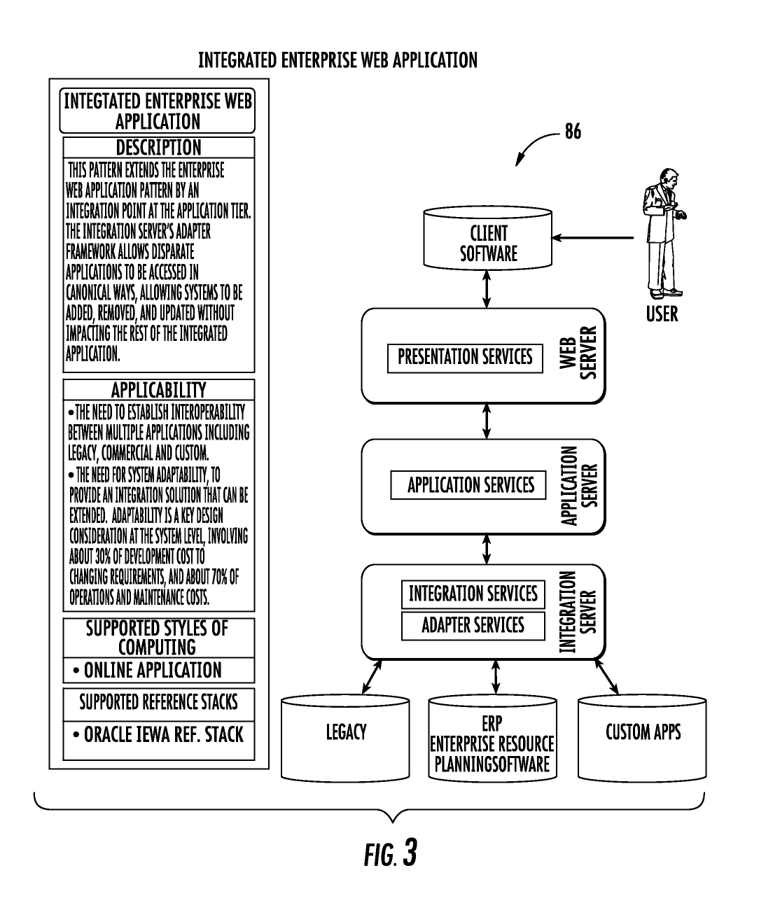

Blueprint generation module 58 comprises programmed logic that directs processor 34 to generate an output and enterprise service system blueprint as indicated by block 118 in FIG. 3. Blueprint generation module 58 generates the blueprint using the archetype or group of archetypes identified in block 116 of FIG. 3. In the example illustrated, blueprint generation module 58 effectively “fills in the blanks” for each of the unspecified classes of products set forth in the selected or identified archetype. In one implementation, blueprint generation module 58 directs processor 34 to access knowledge base 29 and to search the metadata associated with the candidate products to identify particular products for each class of products identified in the archetype or group of archetypes identified by archetype search module 56. In one implementation, blueprint generation module 58 automatically selects the products based upon the system requirements and the solution model criteria. In one implementation, blueprint generation module 58 further takes into account customer requests presented to input 30. In yet another implementation, blueprint generation module 58 presents on output 32 a list of possible actual products to the user or architect for selection by the user architect to fill in the product class or category listed in the selected archetype.

Blueprint generation module 58 comprises code or logic that compares ports, connections, security and other characteristics of each archetype candidate product to ensure compatibility between the different archetype products. In circumstances where to originally identified archetype products are not compatible with one another, system 20 returns to block 116 and searches and identifies an alternative arc type artifact for the archetype artifact that was found not to be compatible. Blueprint generation module 58 automatically and heuristically assembles the archetype products to generate blueprint.

In one implementation, the blueprint generated by module 58 and system 20 comprises a listing of archetype products and configuration settings for each archetype product. The blueprint generated by module 58 also contains an infrastructure model which identifies each of the configurations and specifications for an infrastructure, such as network connections and the like, connecting the archetype products. In one implementation, the blueprint output by system 20 additionally comprises a bill of materials of the components or products, infra configuration specifications and deployment models, processes, steps and the like. For example, with respect to servers, such infra configurations and the bill of materials provide information like the type of physical server, model number, number of cores of CPU, memory, NIC cards, and many other parameters that help define the infrastructure. The blueprint output by system 20 has sufficient detail regarding what real-world components or products are to be used, how they are to be configured, how they are to be interconnected and how they are to be deployed such that the enterprise service system defined by the blueprint is implementable by a technician, with the technician simply following the diagrammed or outlined instructions of the blueprint.

In one implementation, the blueprint is has multiple levels or tiers. For example, in one implementation, system 20 outputs a blueprint for the primary system or general system based upon the entered primary system service requirements and the entered criteria for the primary system solution model. The resulting blueprint may identify multiple subsystems. In one implementation, the blueprint may identify a detailed specification for a technician implementing the subsystem. However, there may be additional or alternative technical requirements and business requirements for each subsystem which are not germane or relevant to the overall or primary system requirements. In such an implementation, system 20 additionally allows a user or enterprise architect to select a subsystem identified on the primary system blueprint for further revision or modification.

In one implementation, upon a subsystem being selected for further modification, system 20 repeats method 100 for the selected subsystem. In particular, module 50 prompts for and receives requirements for the subsystem. Module 52 direct processor 34 to search the general solution model repository or a dedicated subsystem solution model repository for a subsystem solution model based upon the subsystem requirements received in block 110. Criteria model 54 prompts for and received constraints or criteria for the functional elements of the subsystem solution model based upon the identified subsystem solution model as described with respect to block 114. Module 56 directs processor 34 to search the archetype database 28 or a dedicated subsystem archetype database based upon the functional elements of the subsystem solution model and the subsystem criteria to identify archetype artifacts that may satisfy the subsystem requirements and the subsystem criteria. Module 58 direct processor 34 to generate an output a subsystem blueprint. Like the primary system blueprint, the subsystem blueprint has sufficient detail regarding what real-world components or products are to be used, how they are to be configured, how they are to be interconnected and how they are to be deployed such that the subsystem of the enterprise service system defined by the subsystem blueprint is implementable by a technician, with the technician simply following the diagrammed or outlined instructions of the subsystem blueprint.

The generated blueprint is output on output 32. As noted above, the generated blueprint may be presented or displayed on a screen for viewing and/or may be stored for subsequent retrieval and possible modification, such as when a user or enterprise service architect wishes to modify the blueprint such as by modifying a subsystem of the primary system blueprint. In addition, in one implementation, resulting blueprint is further stored in archetype database 28 for future use in the generation of future blueprints. As a result, system 20 becomes more developed over time, including a greater library or database from which to retrieve archetypes which may serve as outlines for solution models in repository 24 or which may serve as catalogs for different actual real-world archetype artifacts that may be employed in subsequent blueprints.

FIG. 5 schematically illustrates enterprise service blueprint generator 220, another implementation of generator 20. Generator 220 is similar to blueprint generator 20 except that blueprint generator 220 additionally comprises success factor database to 24 and success factor module 228. Those remaining elements of system 220 which correspond to system 20 are numbered similarly.

Success factor database 224 comprises a persistent memory storage device or server accessible database of various characteristics or factors that have been previously identified as being beneficial towards a successful enterprise service in a particular business or industry domain. Such success factors may serve as inputs for system requirements for an enterprise system for which a blueprint is being generated by system 220. Examples of domain associated success factors contained in success factor database 224 include but are not limited to, the solution must be delivered within a certain time frame or the solution must not allow any security breaches.

Success factor module 228 comprises programmed logic that directs processor 34 to prompt for and request a user or architect to identify a particular domain (business environment) for the enterprise service system for which a blueprint is to be generated or characteristics of the domain. Success factor module 228 further directs processor 34 to utilize the input domain information to search success factor database 2244 success factors associated with the particular domain. Once retrieved, success factor module 228 supplies the success factors to system requirements module 50 which utilizes the success factors in the search for solution models in repository 24. System 220 allows a user or enterprise service architect to quickly identify previously identified success factors for a specific domain to ensure that enterprise service system for which the blueprint is being generated is more likely to incorporate such proven success factors.

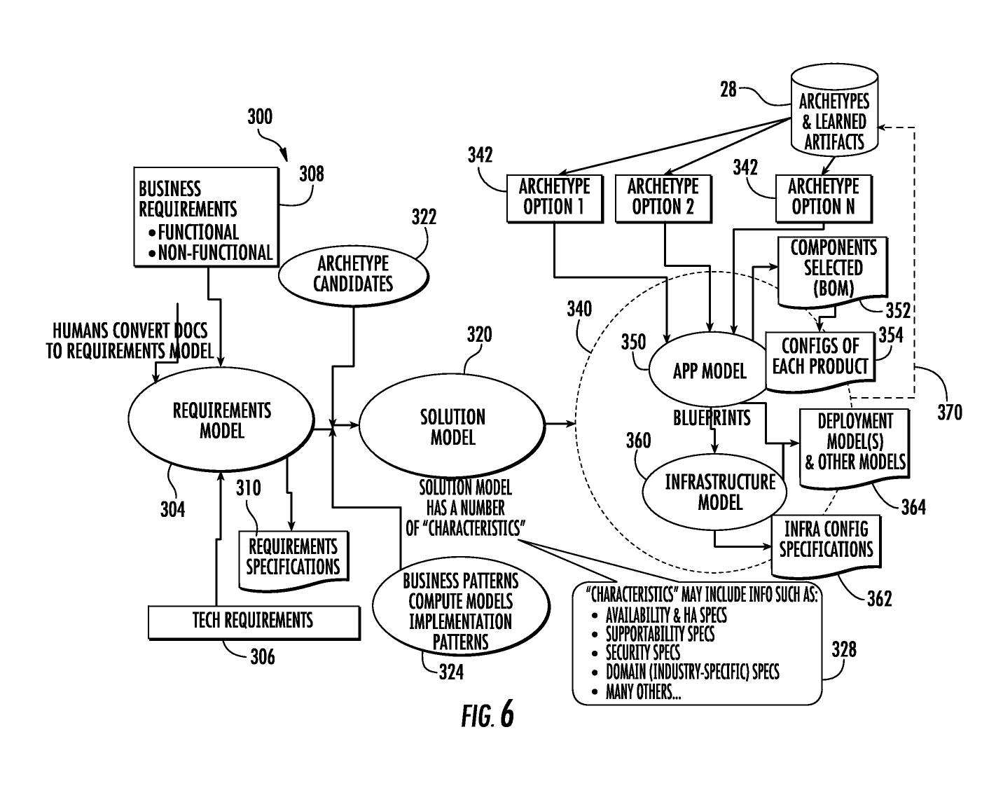

FIG. 6 is a functional flow diagram illustrating an example method 300 for generating enterprise service system blueprint. As indicated by block 304, method 300 involves the acquisition or generation of a requirements model. The requirements model comprises both technical requirements 306 and business requirements 308. The technical requirements 306 pertain to information technology requirements such as compatibility, security and the like. Business or industry requirements 308 may be functional business requirements or objectives, such as what tasks a system or application should do, or may be non-functional business requirements or objectives, such as how well or how fast the system or application should perform the tasks. Such requirements serve as constraints upon the ultimate enterprise service system to be built, but lacks sufficient specificity, in and of themselves, to facilitate building of the enterprise service system. The requirements model may result in the output of requirements specifications 310.

Method 300 utilizes the requirements model 304 to identify, locate or generate solution model 320. In one implementation, solution model 320 is at least partially retrieved from a solution model repository, such as repository 24 described above. In some implementations, at least portions of solution model 320 are generated from multiple sources. For example, in one implementation, solution model 320 is derived from candidate archetypes 322 and other information 324 such as business patterns, computational models, implementation patterns and the like.

As shown by FIG. 6, solution model 320 has a number of possible variables or “characteristics” 328. Method 300 requests input from the user or enterprise service architect regarding such characteristics. Examples of such characteristics include, but are not limited to, availability specification supportability specifications, security specifications and domain or industry-specific specifications, described above. Such criteria for such characteristics is used by method 300 in the search for archetypes, archetype artifacts and the selection of such archetypes and archetype artifacts when generating a blueprint.

Using the identified solution model 320, the criteria for the characteristic 328 (and possibly requirements model 304), method 300 generates blueprints 340. As shown by FIG. 6, blueprints 340 are constructed from different archetypes and archetype artifacts 342 retrieved from and archetype database 28. In the example illustrated, the blueprints 340 comprises an application model 350 which includes a bill of materials 352 for the selected archetype artifact components and products as well as specific instructions or configuration settings 354 for each archetype artifact product.

Blueprints 340 additionally comprises an infrastructure model 360. Infrastructure model 360 provides a framework or platform for connecting and/or facilitating cooperation between their areas archetype artifact components or products. Infrastructure model 360 comprises in front configuration specifications 362 and deployment models 364. Such deployment model 364 provide detailed instructions for interconnecting and facilitating compatibility in cooperation amongst the different archetypes artifact products.

As indicated by broken arrow 370, in one implementation, blueprints 340 are further uplifted to archetype database 28. Such uplifted blueprints 345 additional archetypes and archetype artifacts (products) from which future blueprints may be generated. As a result, database 28 becomes more developed over time, including a greater library or database from which to retrieve archetypes which may serve as outlines for solution models in repository 24 or which may serve as catalogs for different actual real-world archetype artifacts that may be employed in subsequent blueprints.

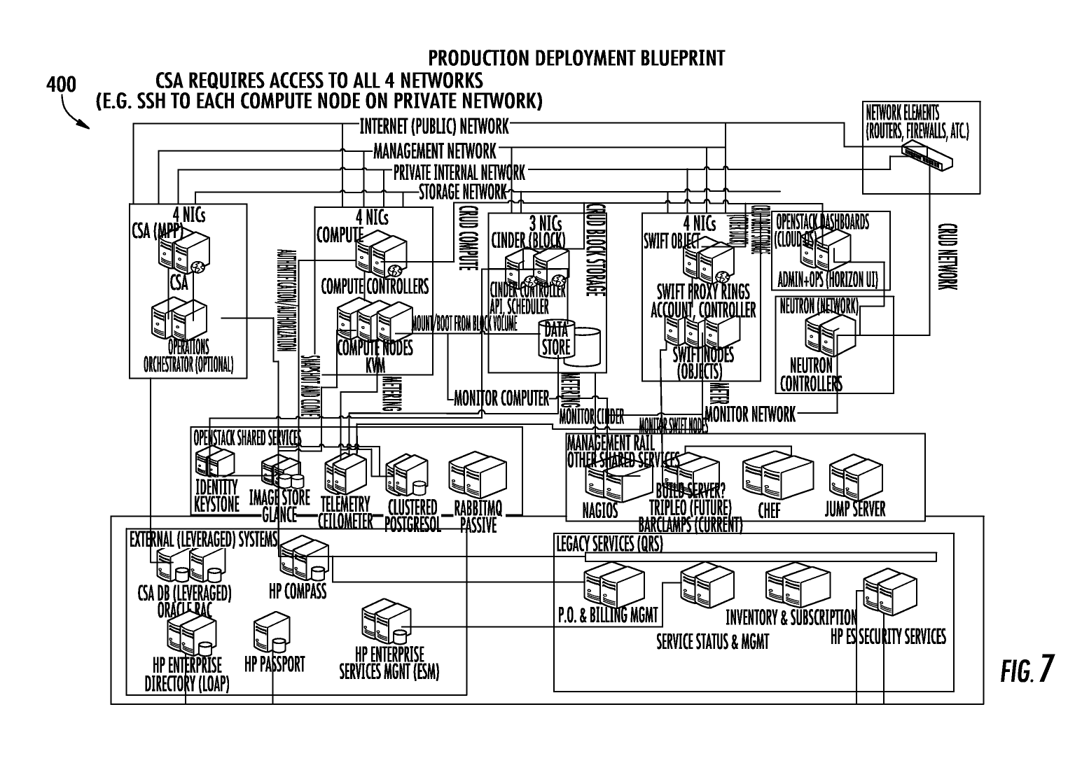

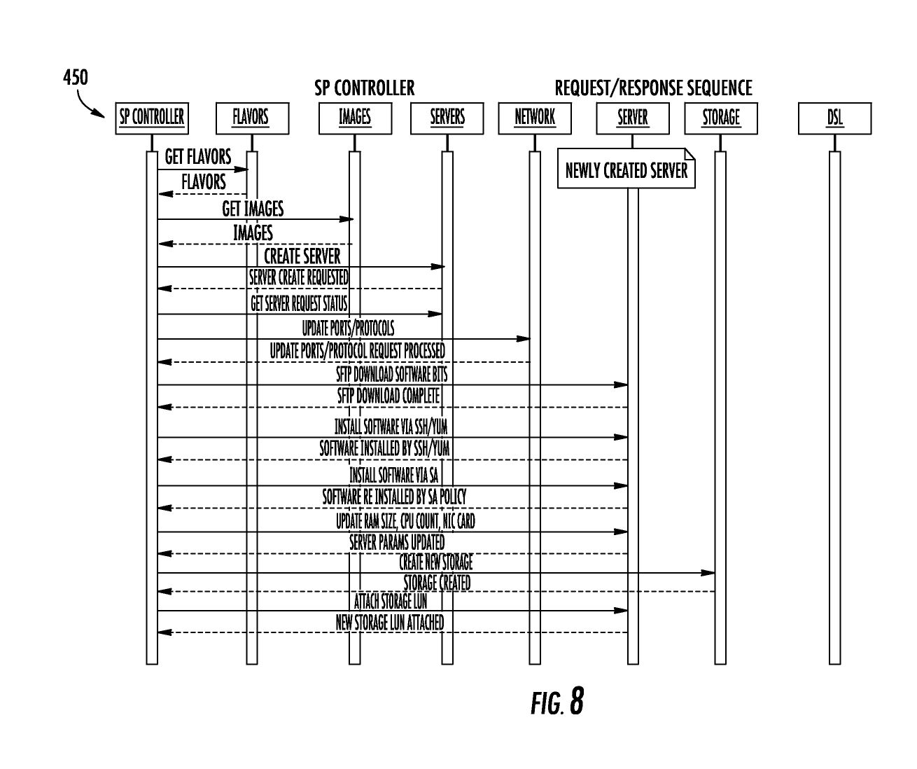

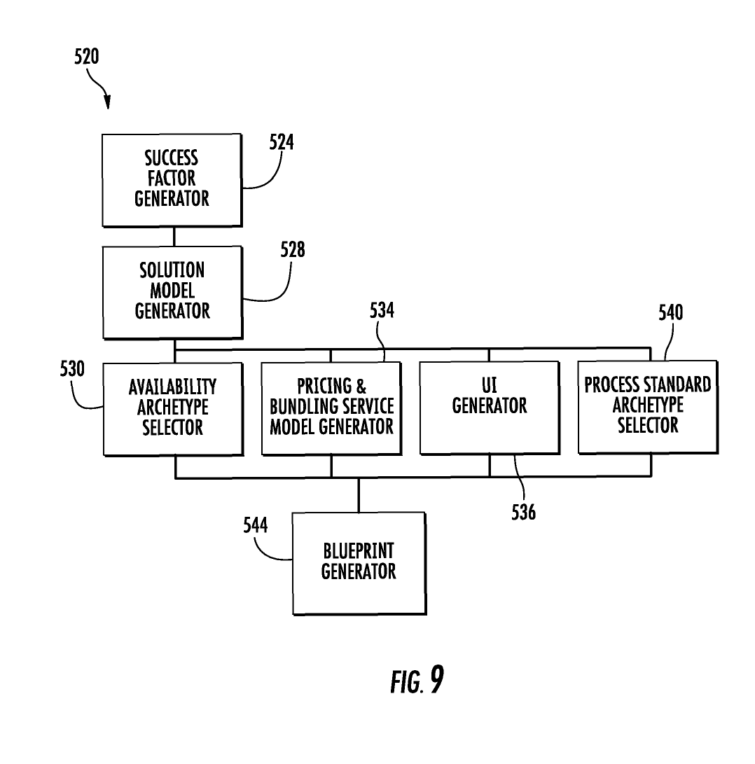

FIGS. 5 and 6 illustrate examples components of blueprint 340 that may be generated using method 300. FIG. 7 illustrates a production deployment blueprint 400. As shown by FIG. 7, production deployment blueprint 400 identifies the specific physical hardware recommended for the enterprise system being developed, their specific connections and quantities. FIG. 8 illustrates another component of blueprint 340, a request/response sequence 450 for the enterprise services system. Blueprint 340 includes additional components as well. As noted above, blueprint 340 comprise components of sufficient detail to allow the enterprise service system to be built out following such blueprints.

FIG. 9 is a block diagram schematically illustrating enterprise service system blueprint generator 520, another example implementation of blueprint generator 20. Blueprint generator 520 comprises success factor generator 524, solution model generator 528, availability archetype selector 530, pricing and bundling service model generator 534, user interface generator 536, process standard archetype selector 540 and blueprint generator 544.

Success factor generator 524 comprises software embodied in a non-transitory computer-readable medium to direct a processor to automatically retrieve or identify a success factor or multiple success factors for an enterprise service model based upon an input indicating the particular domain, business or industry in which the enterprise service system is to operate. In one implementation, success factor generator 524 comprises success factor module 228 (described above) which prompts for input regarding a particular domain in which searches a success factor database, such as success factor database 224, to identify historically proven success factors for an enterprise service system in a particular domain. Such identified success factors are supplied to solution model generator 528 along with others system requirements for the generation or identification of a solution model.

Solution model generator 528 comprises software embodied in a non-transitory computer-readable medium to direct a processor to identify or generate a solution model, such as solution model 320 (described above) based upon system requirements, such as provided by requirements model 304 (described above) and any success factors provided by success factor generator 524. The solution model output by solution model generator 528 serves as a basic framework or outline of functional elements that may satisfy the system requirements input by a user or enterprise service architect. The solution model identified or generated drives further requests for additional input from the user or service architect for criteria regarding the functional aspects of the solution model.

Availability archetype selector 530 comprises software embodied in a non-transitory computer-readable medium to direct a processor to identify archetype products and archetypes for use in the generation of a detailed service blueprint based upon availability criteria for the solution model. In one implementation, availability archetype selector 530 searches archetype database 28 and knowledge-based 29 for specific words, index values, characteristics or the like which are focused on providing high levels of availability, such as high levels of uptime for a service or website.

Pricing and bundling services model generator 534 comprises software embodied in a non-transitory computer-readable medium to direct a processor to provide pricing and bundling service models for use in preparation of the blueprint. In one implementation, generator 534 searches archetype database 28 and knowledge-based 29 for prior archetypes and archetype products with a focus on identifying those archetypes or archetype products related to the pricing and bundling of services that satisfy system requirements and solution model criteria. In one implementation, generator 534 generates service pricing and bundling packages for the blueprint based upon the solution model, the solution model criteria and the service requirements.

User interface generator 536 comprises software embodied in a non-transitory computer-readable medium to direct a processor to provide a user interface models for use in preparation of the blueprint. Such models may include different formats for different display devices as well as different graphical user interface layouts for different display devices. In one implementation, generator 536 searches archetype database 28 and knowledge-based 29 for prior archetypes and archetype products with a focus on identifying those archetypes or archetype products related to the user interfaces that satisfy system requirements and solution model criteria. In one implementation, generator 536 generates user interface mockups for the blueprint based upon the solution model, the solution model criteria and the service requirements.

Process standard archetypes selector 540 comprises software embodied in a non-transitory computer-readable medium to direct a processor to identify those archetypes and archetype artifacts that satisfy process standards are criteria for use in preparation of the blueprint. For example, in one implementation, selector 540 searches archetype database 28 and knowledge-base 29 with a focus on identifying those archetypes and archetype products that satisfy one or more predefined sets of information technology management standards, such as information technology infrastructure library (ITIL) standards or Six Sigma thresholds are standards. In one implementation, selector 540 prompts a user or an enterprise architect to identify, as criteria, those process or information technology standards to be satisfied.

Blueprint generator 544 comprises software embodied in a non-transitory computer-readable medium to direct a processor to generate an output and enterprise service system blueprint, such as blueprint 340 described above. Blueprint generation module 544 generates the blueprint using the archetype artifacts identified by at least one of selector 530, generator 534, generator 536 and selector 540. Blueprint generator 544 comprises code or logic that compares ports, connections, security and other characteristics of each art type artifact to ensure compatibility between the different archetype artifacts. In circumstances where to originally identified archetype artifacts are not compatible with one another, generator 544 searches and identifies an alternative archetype artifact for the archetype artifact that was found not to be compatible. Generator 544 automatically and heuristically assembles the archetype artifacts to generate blueprint.

In one implementation, the blueprint generated by generator 544 comprises a listing of archetype artifact products and configuration settings for each archetype artifact product. The blueprint generated by generator 544 also contains an infrastructure model which identifies each of the configurations and specifications for an infrastructure, such as network connections and the like, connecting the archetype artifact products. In one implementation, the blueprint output by generator 544 additionally comprises a bill of materials of the components or products, infra configuration specifications and deployment models, processes, steps and the like. The blueprint output by generator 544 has sufficient detail regarding what real-world components or products are to be used, how they are to be configured, how they are to be interconnected and how they are to be deployed such that the enterprise service system defined by the blueprint is implementable by a technician, with the technician simply following the diagrammed or outlined instructions of the blueprint.

While the preferred embodiments of the invention have been illustrated and described, it will be appreciated that various changes can be made therein without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific embodiments of the present invention.

What is claimed is:

1. A method comprising:
receiving an input indicating primary system enterprise service requirements;
keyword searching a repository based upon the primary system service requirements to identify a solution model, the solution model comprising a framework of functional elements for the primary system service requirements;
prompting for and receiving criteria regarding the identified functional elements;
identifying archetypes and archetype products based on the functional elements and the criteria to identity archetypes and archetype products; and
generating and presenting a primary system blueprint comprising the archetype products, the primary system blueprint comprising an application model and an infrastructure model, wherein the application model comprises a listing of archetype products and configuration settings for each archetype product and wherein the infrastructure model comprises specifications for an infrastructure connecting the archetype products.

2. The method of claim 1 further comprising receiving an input indicating a domain for the success factor, wherein the solution model is further identified based upon the domain.

3. The method of claim 1 further comprising:
receiving an input indicating a domain;
accessing a success factor database and retrieving candidate success factors for the domain; and
presenting the retrieved candidate success factors; and
prompting for and receiving a selected success factor from the candidate success factors, wherein the selected candidate success factor serves as one of the service requirements.

4. The method of claim 1, wherein the criteria regarding the identified functional elements comprise service level objectives.

5. The method of claim 1, wherein the archetype products comprise different pricing and bundling service models based on an expected usage pattern.

6. The method of claim 1, wherein the archetype products comprise different candidate mocked up user interface models.

7. The method of claim 1, wherein the criteria regarding the identified functional elements comprises open-source usage criteria, wherein the archetype products are retrieved based on the input regarding open-source usage criteria.

8. The method of claim 1, wherein the criteria regarding identified functional elements comprise criteria consisting of: security specifications, availability specifications, supportability specifications and domain-industry-specific specifications.

9. The method of claim 1, wherein the primary system blueprint comprises a subsystem and wherein the method further comprises:
receiving an input indicating subsystem service requirements;
keyword searching a repository based upon the subsystem service requirements to identify a solution model for the subsystem, the solution model for the subsystem comprising a framework of subsystem functional elements for the subsystem service requirements;
prompting for and receiving criteria regarding the identified subsystem functional elements;
searching an archetype database based on the functional elements for the subsystem and the criteria to identity subsystem archetypes and archetype products to perform functions of the subsystem functional elements; and
generating and presenting a subsystem blueprint comprising the archetype products, the blueprint comprising a subsystem application model and a subsystem infrastructure model, wherein the subsystem application model comprises a listing of archetype products and configuration settings for each subsystem archetype product and wherein the subsystem infrastructure model comprises specifications for a subsystem infrastructure connecting the subsystem archetype products.

10. The method of claim 1 further comprising prompting and receiving a value associated with an importance of each of the primary system service requirements, wherein the solution model is identified based upon a comparison of the value associated with each primary system service requirement.

11. The method of claim 1 further comprising prompting and receiving a value associated with an importance of each of the criteria, wherein the archetype products are identified based upon a comparison of the value associated with each criteria.

12. The method of claim 1 further comprising populating the archetype database with the blueprint as a future archetype.

13. An apparatus comprising:
a non-transitory computer-readable medium containing program logic to direct a processor to:
receive an input indicating system service requirements;
search a repository based upon the primary system service requirements to identify a solution model, the solution model comprising a framework of functional elements for the primary system service requirements;
prompt for and receive criteria regarding the identified functional elements;
identify and archetype and archetype products based on the functional elements and the criteria; and
generate and present a blueprint comprising the archetype products, the primary system blueprint comprising an application model and an infrastructure model, wherein the application model comprises a listing of archetype products and configuration settings for each archetype product and wherein the infrastructure model comprises specifications for an infrastructure connecting the archetype products.

14. The apparatus of claim 13, wherein the program logic is to direct the processor to store the blueprint in the archetype database as a future archetype.

15. A service blueprint generator system comprising:
a success factor generator to retrieve success factors based upon an input identifying an industry;
a solution model generator to generate a solution model based upon the retrieved success factors and system service requirements, the solution model comprising a framework of functional elements for the system service requirements;
a blueprint generator to generate and present a service blueprint comprising archetype products, the service blueprint comprising an application model and an infrastructure model, wherein the application model comprises a listing of archetype products and configuration settings for each archetype product and wherein the infrastructure model comprises specifications for an infrastructure connecting the archetype products
a process standard archetype selector to identify candidate archetype products for the service blueprint based upon a predefined set of information technology management standards;
an availability archetype selector to identify candidate archetype products for the service blueprint based upon availability criteria for the solution model;
a service level objectives generator to generate service level objectives for the service blueprint;
a pricing and bundling service model guidance tool to generate pricing models for the service blueprint; and
a user interface mockup generator to generate a user interface for the service blueprint based upon the system service requirements.
